(19) United States
(12) Patent Application Publication
(10) Pub. No.: US 2016/0202703 A1
(43) Pub. Date: Jul. 14, 2016

(54) SELF-PROPELLED ELECTRONIC DEVICE

(71) Applicant: SHARP KABUSHIKI KAISHA, Osaka-shi, Osaka (JP)

(72) Inventor: Takashi MATSUBARA, Osaka-shi (JP)

(21) Appl. No.: 14/912,194

(22) PCT Filed: Feb. 21, 2014
(86) PCT No.: PCT/JP2014/054180

§ 371 Date: Feb. 16, 2016

(30) Foreign Application Priority Data
Sep. 9, 2013 (JP) 2013-186303

(51) Int. Cl. G05D 1/02; B08B 13/00

(52) U.S. Cl. CPC G05D 1/0219; B08B 13/00; G05D 2201/0215; G05D 2201/0203

(57) ABSTRACT

A self-propelled electronic device including: a housing capable of traveling on a travel surface; a drive unit for driving the housing to travel; a traveling sensor for sensing a condition on the travel surface and for outputting a signal; and a control unit for controlling the drive unit based on the signal output from the traveling sensor, wherein the control unit controls driving operation of the drive unit to stop when determining that there is no change in the signal output from the traveling sensor while the housing travels for a predetermined travel distance or for a predetermined period.

### TECHNICAL FIELD

The present invention relates to a self-propelled electronic device, and more particularly to a self-propelled electronic device that senses an obstacle on a travel surface to control traveling.

### BACKGROUND ART

A robotic vacuum cleaner has been known as one embodiment of a self-propelled electronic device (see, for example, Patent Document 1). Compared to an ordinary vacuum cleaner, a robotic vacuum cleaner has an autonomous traveling function on its body for performing unmanned cleaning while autonomously traveling. As a different embodiment of a self-propelled electronic device, a self-propelled air cleaner robot aiming to eliminate floating dust from every corner of a room has been proposed (see, for example, Patent Document 2).

Such self-propelled electronic devices are provided with various sensors for performing a job which is the original purpose. For example, a self-propelled electronic device travels in a room while performing a job, and includes an obstacle sensor to avoid obstacles in the room while traveling. An obstacle sensor that self-diagnoses failures, stops driving of the robotic vacuum cleaner when a failure is found, and reports the failure has been proposed (see, for example, Patent Document 3). Specifically, when a bumper sensor for detecting collision detects a collision against an obstacle, a drive unit is driven to allow the device to retreat by a certain distance, and when the repeat count of retreat reaches a reference number of times or more, the drive unit is stopped.

However, in some cases, the self-propelled electronic device is stalled and cannot travel, in other words, the self-propelled electronic device is stuck, because there are a variety of types and shapes of obstacles. For example, it is likely to occur that a housing rides on a height difference in a room formed from a threshold still, a carpet, or a power cord. It is also likely to occur that, when the device enters below a sofa placed with a gap with a certain height from the travel surface, the device cannot pass due to a contact between the top of the device and the bottom of the sofa.

When a self-propelled electronic device having a drive wheel for traveling remains stuck, and keeps rotating the drive wheel as staying on the same place, for example, the floor surface, tatami mat, carpet, or item where the drive wheel is in contact might be damaged. It is preferable that the device reliably detects the situation in which the device is brought into a stuck state, and tries to be free from the stuck state, and when the device is still unable to be free from the stuck state, driving is stopped.

### CITATION LIST

### Patent Document

Patent Document 1: Japanese Unexamined Patent Publication No. 2004-195215
Patent Document 2: Japanese Unexamined Patent Publication No. 2005-331128
Patent Document 3: Japanese Unexamined Patent Publication No. 2008-134984

### SUMMARY OF THE INVENTION

### Problem to be Solved by the Invention

A conventional self-propelled electronic device includes a free wheel separately from a drive wheel for traveling a housing, for example, and determines whether the device is stuck or not by monitoring the rotation of the free wheel, in order to detect that the device is stuck and take appropriate measures. Alternatively, the conventional self-propelled electronic device is provided with a geomagnetic sensor in the housing, and determines whether the device is stuck or not by monitoring the output from the geomagnetic sensor.

However, the above techniques need a dedicated sensor or a circuit used for stuck detection, entailing a large burden of cost. Specifically, a circuit for detecting a rotation of a free wheel and a circuit for a geomagnetic sensor is provided not for the original job of the self-propelled electronic device, but for stuck detection.

The present invention is accomplished in view of the above circumstances and aims to provide a self-propelled electronic device that can determine whether the device is stuck or not without providing a dedicated sensor or circuit.

### Means for Solving the Problems

The present invention provides a self-propelled electronic device including: a housing capable of traveling on a travel surface; a drive unit for driving the housing to travel; a traveling sensor for sensing a condition on the travel surface and for outputting a signal; and a control unit for controlling the drive unit based on the signal output from the traveling sensor, wherein the control unit controls driving operation of the drive unit to stop when determining that there is no change in the signal output from the traveling sensor while the housing travels for a predetermined travel distance or for a predetermined period.

### Effect of the Invention

In the present invention, the control unit controls driving operation of the drive unit to stop when determining that there is no change in a signal output from the traveling sensor while the housing travels for a predetermined distance or travel for a predetermined period. Therefore, whether the device is stuck or not can be determined by using a traveling sensor used for autonomous traveling without providing a dedicated sensor or a circuit.

### BRIEF DESCRIPTION OF THE DRAWINGS

FIG. 1 is a block diagram illustrating a schematic configuration of a self-propelled vacuum cleaner which is one embodiment of a self-propelled electronic device according to the present invention.

FIG. 2 is a perspective view schematically illustrating an external appearance of the self-propelled vacuum cleaner illustrated in FIG. 1.

FIG. 3 is a bottom view schematically illustrating a bottom surface of the self-propelled vacuum cleaner illustrated in FIG. 1.

FIG. 4 is an explanatory view illustrating a detail configuration of an ultrasonic sensor according to the embodiment of the present invention.

FIG. 5 is a waveform chart illustrating one example of a signal waveform of the ultrasonic sensor illustrated in FIG. 4.

FIG. 6 is a flowchart illustrating a procedure of a process executed by a control unit according to the present invention. (First Embodiment)

FIG. 7 is a flowchart illustrating a procedure of a process executed by the control unit according to the present invention. (Second Embodiment)

FIG. 8 is a flowchart illustrating a procedure of a process executed by the control unit according to the present invention. (First Half of Third Embodiment)

FIG. 9 is a flowchart illustrating a procedure of a process executed by the control unit according to the present invention. (Latter Half of Third Embodiment)

### MODE FOR CARRYING OUT THE INVENTION

Hereinafter, the present invention will be described in more detail with reference to the drawings. Note that the description below is an exemplification in all respects, and should not be construed to restrict the invention.

### <<Specific Embodiment of Self-Propelled Electronic Device>>

A self-propelled vacuum cleaner will be described in the embodiments below as one example of a self-propelled electronic device according to the present invention. The self-propelled vacuum cleaner according to the present embodiment includes a housing having an intake port on its bottom surface and a dust collection unit inside; drive wheels that allow the housing to travel; a control unit that controls the rotation, stop, and rotating direction of the drive wheels, and the like. The self-propelled vacuum cleaner autonomously performs a cleaning operation without being manually operated by a user.

The self-propelled electronic device according to the present invention is not limited to a self-propelled vacuum cleaner, and it includes a self-propelled air cleaner that sucks air and discharges purified air, and a self-propelled ion generator that generates ions. Besides, the self-propelled electronic device according to the present invention includes a self-propelled robot that can present information or the like necessary for a user or respond to an action made by the user with sound, expression, behavior, and the like.

### <<Configuration of Self-Propelled Vacuum Cleaner>>

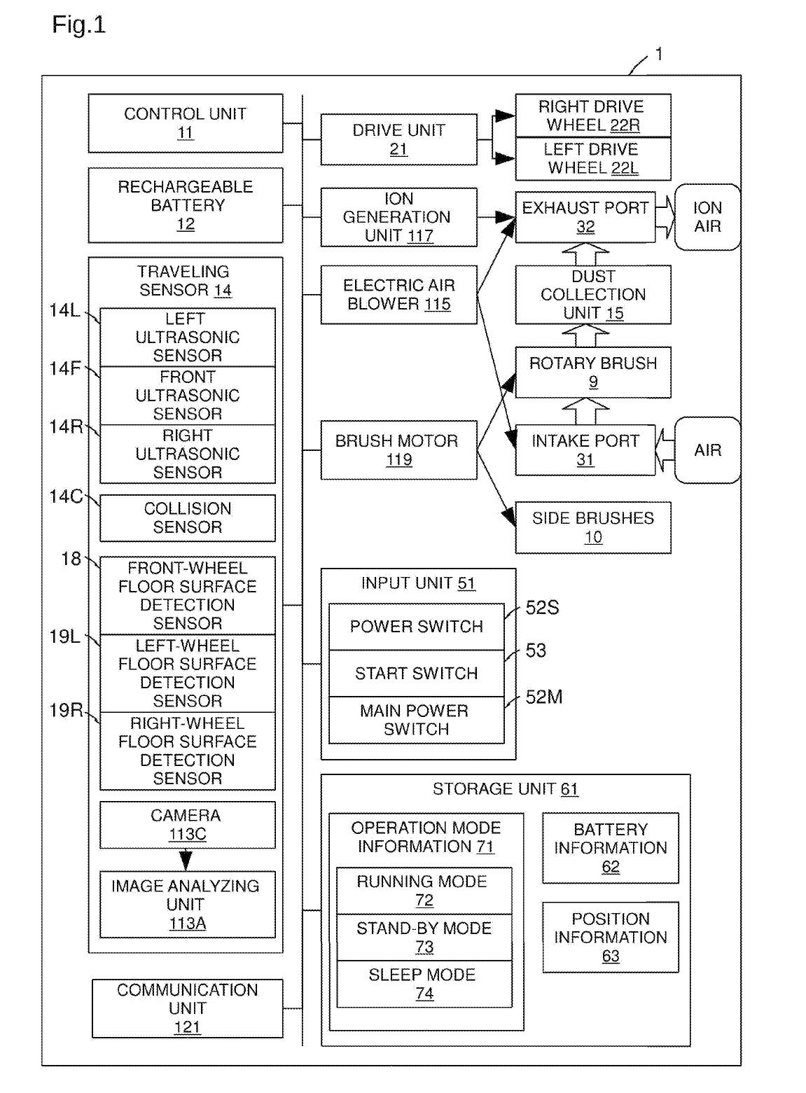

FIG. 1 is a block diagram illustrating a schematic configuration of a self-propelled vacuum cleaner according to one embodiment of the present invention. As illustrated in FIG. 1, the self-propelled vacuum cleaner according to the present invention mainly includes a rotary brush 9, a side brush 11, a control unit 11, a rechargeable battery 12, a traveling sensor 14, and a dust collection unit 15. The self-propelled vacuum cleaner also includes a drive unit 21, a right drive wheel 22R, a left drive wheel 22L, an intake port 31, an exhaust port 32, an input unit 51, a storage unit 61, an electric air blower 115, and an ion generation unit 117.

The self-propelled vacuum cleaner of the invention sucks air including dust on a floor surface in a region where the cleaner is placed, while autonomously traveling on the floor surface, and exhausts air from which the dust is removed to thereby clean the floor surface. The self-propelled vacuum cleaner according to the present invention has a function of autonomously returning to a charging stand, not illustrated, after finishing cleaning.

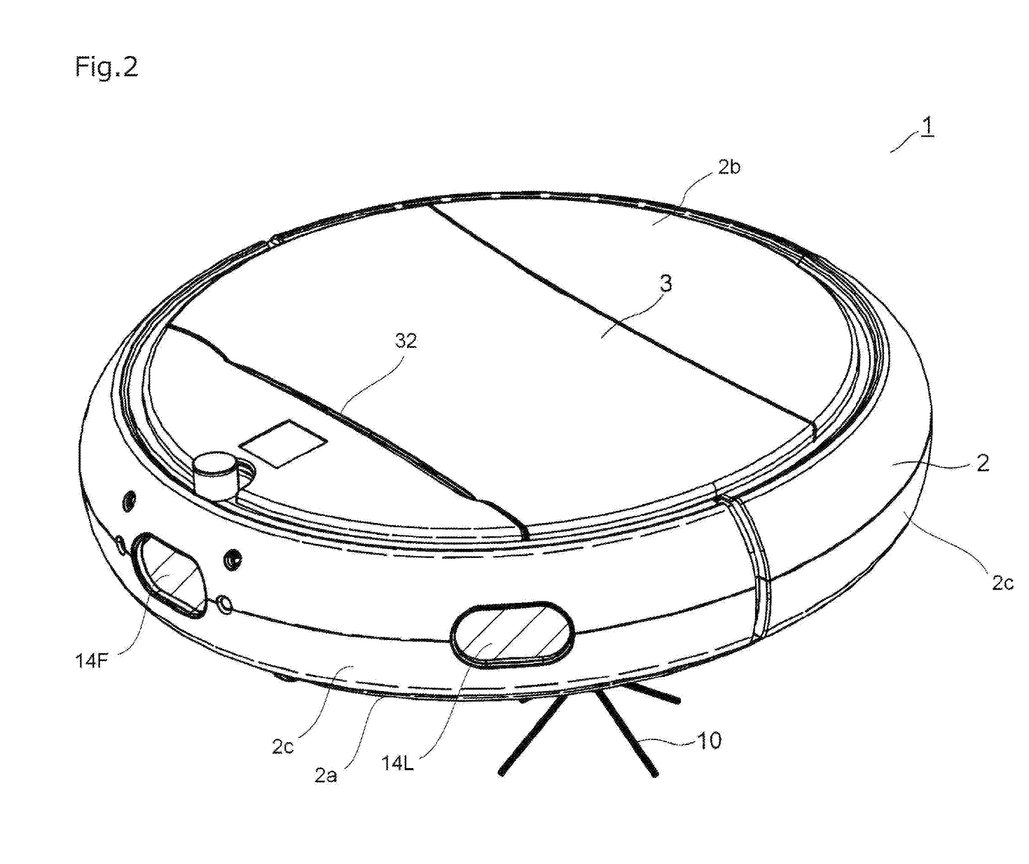

FIG. 2 is a perspective view schematically illustrating an external appearance of the self-propelled vacuum cleaner according to the present embodiment.

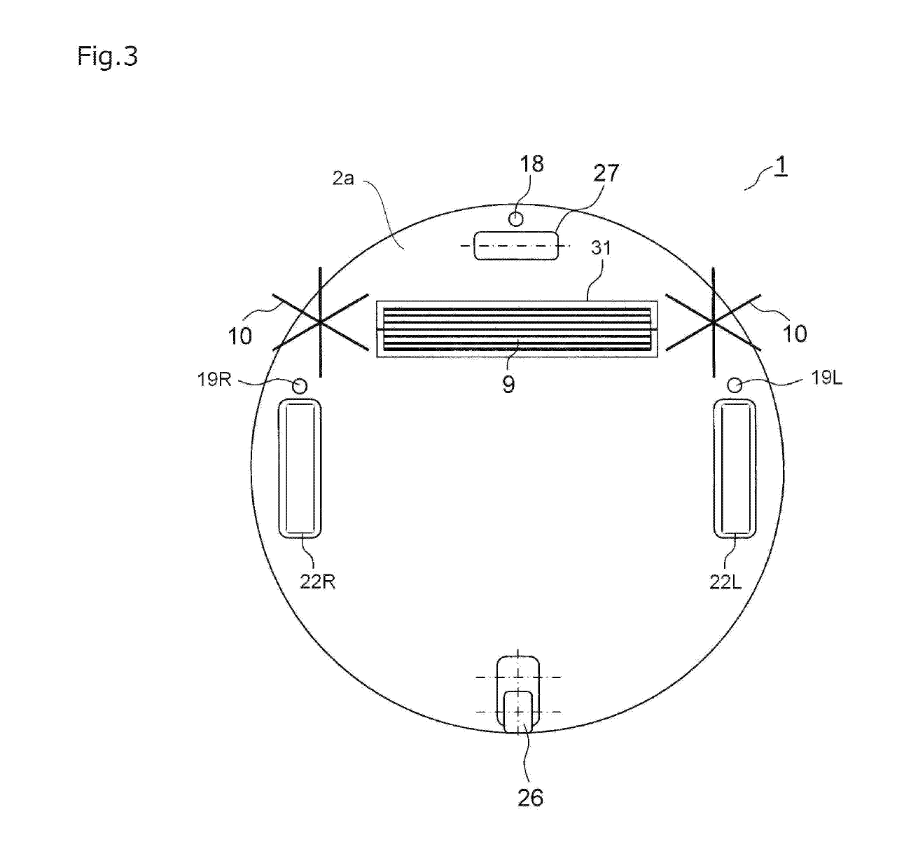

FIG. 3 is a bottom view schematically illustrating a bottom surface of the self-propelled vacuum cleaner according to the present embodiment.

As illustrated in FIG. 2, the self-propelled vacuum cleaner 1 according to the present invention has a disc-like housing 2.

The housing 2 includes a bottom plate 2a; a top plate 2b on which a lid unit 3 is mounted, the lid unit 3 being openable for inserting or extracting a container of the dust collection unit stored in the housing 2; and a side plate 2c that has an annular shape in a plan view and is mounted along an outer periphery of the bottom plate 2a and the top plate 2b. The exhaust port 32 is formed in the vicinity of the boundary between the front part and the intermediate part on the top plate 2b. The side plate 2c is longitudinally separated into two which are a front part and a back part. The front part of the side plate functions as a bumper, and also has a collision sensor 14F inside for detecting collision at the front part of the side plate. As illustrated in FIG. 2, a forward ultrasonic sensor 14F is mounted on its front side and a left ultrasonic sensor 14L is mounted on its left side. Although not illustrated in FIG. 2, a right ultrasonic sensor 14R is provided on its right side.

As illustrated in FIG. 3, a plurality of holes from which the front wheel 27, the right drive wheel 22R, the left drive wheel 22L, and a rear wheel 26 are exposed to project to the outside from the housing 2 is formed on the bottom plate 2a. The rotary brush 9 is mounted in the intake port 31; side brushes 10 are mounted at the left and right of the intake port 31; a front-wheel floor surface detection sensor 18 is mounted in front of the front wheel 27; a left-wheel floor surface detection sensor 19L is mounted in front of the left drive wheel 22L; and a right-wheel floor surface detection sensor 19R is mounted in front of the right drive wheel 22R.

The self-propelled vacuum cleaner 1 moves forward by forward rotations of the right drive wheel 22R and the left drive wheel 22L in the same direction, and travels in the direction in which the forward ultrasonic sensor 14F is mounted. The self-propelled vacuum cleaner 1 moves backward by reverse rotations of the right drive wheel 22R and the left drive wheel 22L in the same direction, and turns with the rotations of the right drive wheel 22R and the left drive wheel 22L in the opposite direction. For example, the self-propelled vacuum cleaner 1 reduces speeds of the left and right drive wheels, and then, stops, in the case where each sensor in the traveling sensor 14 detects that the self-propelled vacuum cleaner 1 reaches an edge of an area to be cleaned, and in the case where each sensor in the traveling sensor 14 detects an obstacle on a traveling route. Thereafter, the self-propelled vacuum cleaner 1 turns and changes its direction by rotating the left and right drive wheels in the opposite direction. In this way, the self-propelled vacuum cleaner 1 autonomously travels, while avoiding obstacles throughout the entire or desired range of the region where the self-propelled vacuum cleaner 1 is placed.

In the embodiment, it is set such that a front side indicates an advancing direction of the self-propelled vacuum cleaner 1 (in FIG. 3, the direction from the rear wheel 26 to the front wheel 27 on the bottom plate 2a), and a back side indicates a backward direction of the self-propelled vacuum cleaner 1 (in FIG. 3, the direction from the front wheel 27 to the rear wheel 26 on the bottom plate 2a).

Each component illustrated in FIG. 1 will be described below.

### <<Exemplary Configuration of Self-Propelled Electronic Device>>

The control unit 11 in FIG. 1 controls an operation of each component of the self-propelled vacuum cleaner 1, and it is implemented mainly by a microcomputer composed of a CPU, a RAM, an I/O controller, a timer, and the like.

Based on a control program which is preliminarily stored in the later-described storage unit 61 and developed in the RAM, the CPU causes each hardware item to operate organically to thereby execute a cleaning function, a traveling function, and the like according to the present invention.

The rechargeable battery 12 supplies power to each functional element of the self-propelled vacuum cleaner 1, and it mainly supplies power for performing the cleaning function and traveling control. Examples of usable rechargeable batteries include a lithium ion battery, a nickel-metal hydride battery, or an Ni—Cd battery.

The rechargeable battery 12 is charged such that the self-propelled vacuum cleaner 1 is placed close to the charging stand not illustrated, and with this state, exposed charging terminals of the charging stand and the self-propelled vacuum cleaner 1 are brought into contact with each other.

The traveling sensor 14 senses a surrounding condition such as obstacles placed on a travel surface on which the self-propelled vacuum cleaner 1 travels. Especially, the left ultrasonic sensor 14L, the front ultrasonic sensor 14F, and the right ultrasonic sensor 14R, which sense left region, front region, and right region respectively, detect that the self-propelled vacuum cleaner 1 is in contact with or comes close to obstacles such as a wall, a desk, or a chair in a room during traveling. Specifically, the traveling sensor 14 detects that the self-propelled vacuum cleaner 1 is in contact with or comes close to obstacles in a non-contact manner. A non-contact sensor of another type such as an infrared ranging sensor may be used instead of the ultrasonic sensor, or with the ultrasonic sensor.

The collision sensor 14C detects that the self-propelled vacuum cleaner 1 contacts an obstacle during traveling. The collision sensor 14C is mounted at the inside of the side plate 2c of the housing 2. The CPU recognizes that the side plate 2c collides against the obstacle based on an output signal from the collision sensor 14C.

The front-wheel floor surface detection sensor 18, the left-wheel floor surface detection sensor 19L, and the right-wheel floor surface detection sensor 19R detect height difference such as that of descending stairs.

The CPU recognizes a position where an obstacle or a height difference exists based on the signal output from the traveling sensor 14. The CPU determines a direction in which the self-propelled vacuum cleaner 1 is to travel next by avoiding the obstacle or the height difference based on position information of the recognized obstacle and the height difference. In the case where the front-wheel floor surface detection sensor 18 fails to detect a height difference or is broken down, the left-wheel floor surface detection sensor 19L and the right-wheel floor surface detection sensor 19R detect descending stairs to prevent the self-propelled vacuum cleaner 1 from falling down the descending stairs.

The traveling sensor 14 includes a camera 113C and an image analyzing unit 113A.

The camera 113C sequentially photographs a condition ahead of the self-propelled vacuum cleaner 1, and outputs the photographed condition to the image analyzing unit 113A as an image signal. It may be configured such that an image photographed by the camera 113C is transmitted to an external device through a communication unit 121. The external device may be a smartphone, a tablet, or a computer of a user of the self-propelled vacuum cleaner 1. The user can remotely confirm the condition in the room where the self-propelled vacuum cleaner 1 is placed.

The image analyzing unit 113A may also recognize an obstacle which happens to be in the image signal by using a known pattern recognition technology, and calculate (in other words, determine) a direction and a distance to the obstacle. With this embodiment, an obstacle can be detected using the camera 113C.

FIG. 1 illustrates the configuration in which the traveling sensor 14 includes the camera 113C and the sensors which are the left ultrasonic sensor 14L, the front ultrasonic sensor 14F, and the right ultrasonic sensor 14R. However, a configuration in which the traveling sensor 14 includes either one of the camera and the sensors is included in the scope of the present invention.

When an obstacle is present around the self-propelled vacuum cleaner 1, the CPU acquires the information of the obstacle through image analysis by the image analyzing unit 113A.

The drive unit 21 enables traveling with a drive motor that rotates and stops the left and right drive wheels of the self-propelled vacuum cleaner 1. The drive unit 21 can implement traveling condition such as a forward movement, backward movement, turn, and acceleration/deceleration with the configuration of the drive motor capable of independently rotating the left and right drive wheels in both the forward and backward directions.

The intake port 31 and the exhaust port 32 perform intake and exhaust of air for cleaning, respectively.

The dust collection unit 15 executes a cleaning function for collecting debris and dust in a room, and mainly includes a dust collection container not illustrated, a filter unit, and a cover unit covering the dust collection container and the filter unit. The dust collection unit 15 also includes an inflow path communicating with the intake port 31, and an exhaust path communicating with the exhaust port 32. An electric air blower 115 is provided on the exhaust path. The electric air blower 115 generates an air flow which sucks air through the intake port 31, guides the air into the dust collection container through the inflow path, and releases the air, from which dust is removed, to the outside from the exhaust port 32 through the exhaust path.

The rotary brush 9 rotating about a shaft center parallel to the bottom surface is provided in the intake port 31. Side brushes 10 rotating about a rotation shaft center perpendicular to the bottom surface are provided at both of left and right sides of the intake port 31. The rotary brush 9 is formed such that brushes are helically implanted on an outer peripheral surface of a roller serving as the rotation shaft. Each of the side brushes 10 is formed such that a brush bundle is radially provided at a lower end of the rotation shaft. The rotation shaft of the rotary brush 9 and the rotation shafts of a pair of side brushes 10 are pivoted to a part of the bottom plate 2a of the housing 2, and coupled with a brush motor 119 provided in the vicinity thereof through a power transmission mechanism including a pulley and a belt.

This configuration is merely one example. A drive motor exclusively used to rotate the side brushes 10 may be provided.

The self-propelled vacuum cleaner 1 according to the present embodiment includes an ion generating function as an additional function. The ion generation unit 117 is provided on the exhaust path. When the ion generation unit 117 is activated, an air flow released from the exhaust port contains ions (which may be, for example, Plasmacluster ions (registered trademark) or negative ions) generated from the ion generation unit 117. Air containing such ions is exhausted from the exhaust port 32 formed on the top surface of the housing 2. The inside of the room is sterilized and deodorized with the air containing ions. It has been known that negative ions have a relaxing effect on people. In this case, air is exhausted from the exhaust port 32 backward and obliquely upward, which can prevent dust on the floor surface from whirling, whereby cleanliness in the room can be enhanced. In addition, it is possible to eliminate static electricity from dust, whereby collected dust can reliably be discarded.

Notably, a part of ions generated by the ion generation unit 117 may be guided to the inflow path. With this configuration, ions are included in the air flow guided to the inflow path from the intake port 31, so that the dust collection container and the filter, which are not illustrated, in the dust collection unit 15 can be sterilized and deodorized.

The input unit 51 is used by a user to input an operation instruction to the self-propelled vacuum cleaner 1, and it is provided as an operation panel or an operation button on the surface of the housing of the self-propelled vacuum cleaner 1.

A remote control unit is provided separately from the operation panel or the operation button mounted on the body of the cleaner, and this remote control unit also corresponds to the input unit 51. When an operation button provided on the remote control unit is depressed, infrared or wireless radio signal is transmitted from the remote control unit, and operation instruction is input with wireless communication.

The input unit 51 includes a main power switch 52M, a power switch 52S, and a start switch 53. The main power switch 52M changes on/off of power supply from the rechargeable battery 12 to the control unit 11 and the like through a circuit operation. The power switch 52S turns on/off a power source of the self-propelled vacuum cleaner 1. The start switch 53 is used to start a cleaning operation. Other switches (for example, a charging request switch, an operation mode switch, and a timer switch) are also provided as the input unit 51. When the remote control unit serving as the input unit 51 receives a user's instruction, the control unit 11 controls the drive unit 21 to allow the self-propelled vacuum cleaner 1 to travel in the direction instructed by the user or to stop the self-propelled vacuum cleaner 1, in response to the instruction. Alternatively, the control unit 11 controls ion generation by the ion generation unit 117, for example.

The storage unit 61 stores information necessary for implementing various functions of the self-propelled vacuum cleaner 1 and a control program. A non-volatile semiconductor memory element such as a flash memory or a storage medium such as hard disk is used for the storage unit 61.

The storage unit 61 stores battery information 62 indicating the state of the rechargeable battery 12 such as remaining battery level, position information 63 indicating the current position of the self-propelled vacuum cleaner 1, and operation mode information 71 indicating an operation mode of the self-propelled vacuum cleaner 1, for example. The operation mode information 71 stores a running mode 72, a stand-by mode 73, and a sleep mode 74. The running mode 72 is data indicating that the self-propelled vacuum cleaner 1 is in the running mode for the cleaning operation. The stand-by mode 73 is data indicating that the self-propelled vacuum cleaner 1 is in a stand-by mode in which the cleaner is prepared for starting cleaning in response to the start switch 53. The sleep mode 74 is data indicating that the self-propelled vacuum cleaner 1 is in a sleep mode for saving electricity.

The specific exemplary configuration of a robotic cleaner has been described above. An exemplary configuration of a self-propelled air cleaner is made by changing a part of the self-propelled vacuum cleaner 1 illustrated in FIGS. 1 to 3. Specifically, the self-propelled air cleaner includes an air cleaning unit with a filter for cleaning air, instead of the rotary brush 9, the dust collection unit 15, the ion generation unit 117, and the brush motor 119, and the intake port 31 is formed not on the bottom plate 2a of the housing but on the top plate 2b or the side plate 2c. An exemplary configuration of a self-propelled ion generator is formed by eliminating the rotary brush 9, the dust collection unit 15, and the brush motor 119 from the self-propelled vacuum cleaner 1 illustrated in FIGS. 1 to 3, and the intake port 31 is formed not on the bottom plate 2a of the housing but on the top plate 2b or the side plate 2c.

### First Embodiment

### Exemplary Configuration of Traveling Sensor

Those highly related to the present invention out of the traveling sensor 14 illustrated in FIG. 1 will be described in detail.

An ultrasonic sensor may be used for stuck detection.

The self-propelled vacuum cleaner 1 illustrated in FIG. 1 includes three sensors having different sensing regions, the three sensors being the front ultrasonic sensor 14F, the left ultrasonic sensor 14L, and the right ultrasonic sensor 14R. Only one of the three sensors, or one or more of the three sensors may be used for stuck detection. Preferably, all sensors are used to detect a stuck state.

Whether an obstacle is present or not is determined based on whether or not an ultrasonic microphone 129 detects reflected ultrasonic wave. On the other hand, a stuck state is detected based on whether the detection of the presence of an obstacle or a distance is not changed with time during traveling. When there is no change in the distance or the detection of the presence of an obstacle even during traveling, the self-propelled vacuum cleaner 1 is determined to be in a stuck state. Notably, the case where the self-propelled vacuum cleaner 1 travels in a region having no obstacles around the cleaner is likely to be erroneously determined as the stuck state, since there is no change due to the continued state in which the reflected ultrasonic wave is not detected. However, it is unlikely that the self-propelled vacuum cleaner 1 travels in an unlimited region. Accordingly, it may be determined that the self-propelled vacuum cleaner 1 is in a stuck state, when there is no change even beyond a distance and a time by which the vacuum cleaner 1 travels in a sufficiently wide region.

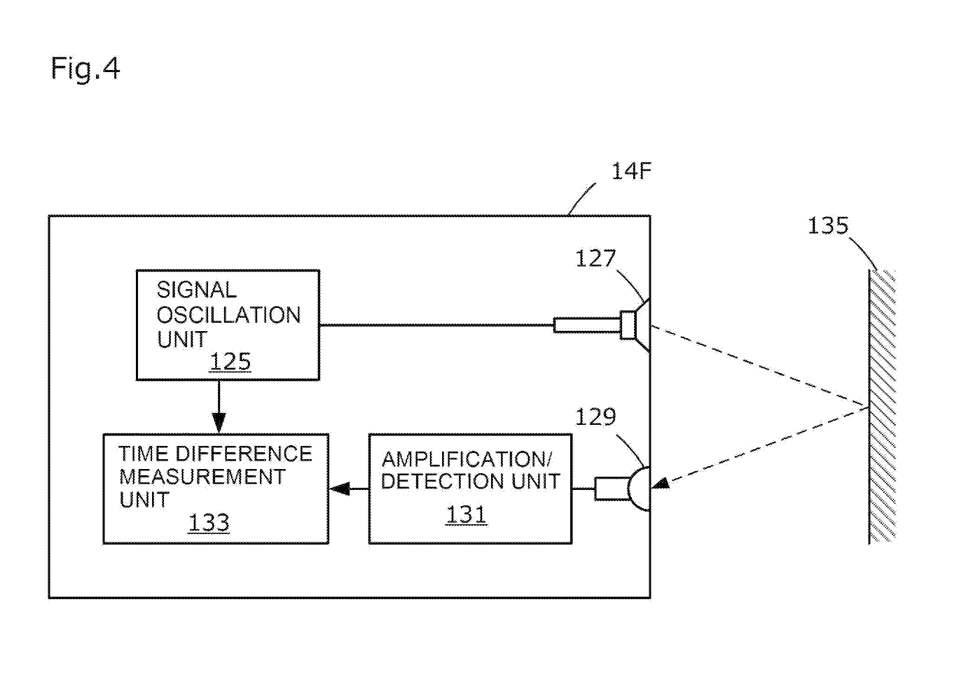

FIG. 4 is an explanatory diagram illustrating the detail configuration of the front ultrasonic sensor 14F according to the present embodiment. The left ultrasonic sensor 14L and the right ultrasonic sensor 14R have the similar configuration.

As illustrated in FIG. 4, the front ultrasonic sensor 14F emits ultrasonic wave to a front side from an ultrasonic speaker 127. When an obstacle 135 is present within a sensing range, the emitted ultrasonic wave is reflected on the obstacle 135, and the reflected ultrasonic wave is detected by the ultrasonic microphone 129. The presence of an obstacle can be determined based on whether or not the emitted ultrasonic wave is reflected. The distance to an obstacle can be estimated based on how much time is taken to detect reflection after the emission.

In FIG. 4, a signal oscillation unit 125 is a circuit that generates a pulse signal with an ultrasonic band which is converted into an ultrasonic wave emitted by the ultrasonic speaker 127. After the ultrasonic wave is converted into an electric signal by the ultrasonic microphone 129, an amplification/detection unit 131 amplifies the level of the electric signal, compares the resultant with a predetermined threshold value, and outputs a binary signal. A time difference measurement unit 133 is a timer circuit that measures a time difference between a pulse signal generated by the signal oscillation unit 125 and a binary signal output from the amplification/detection unit 131.

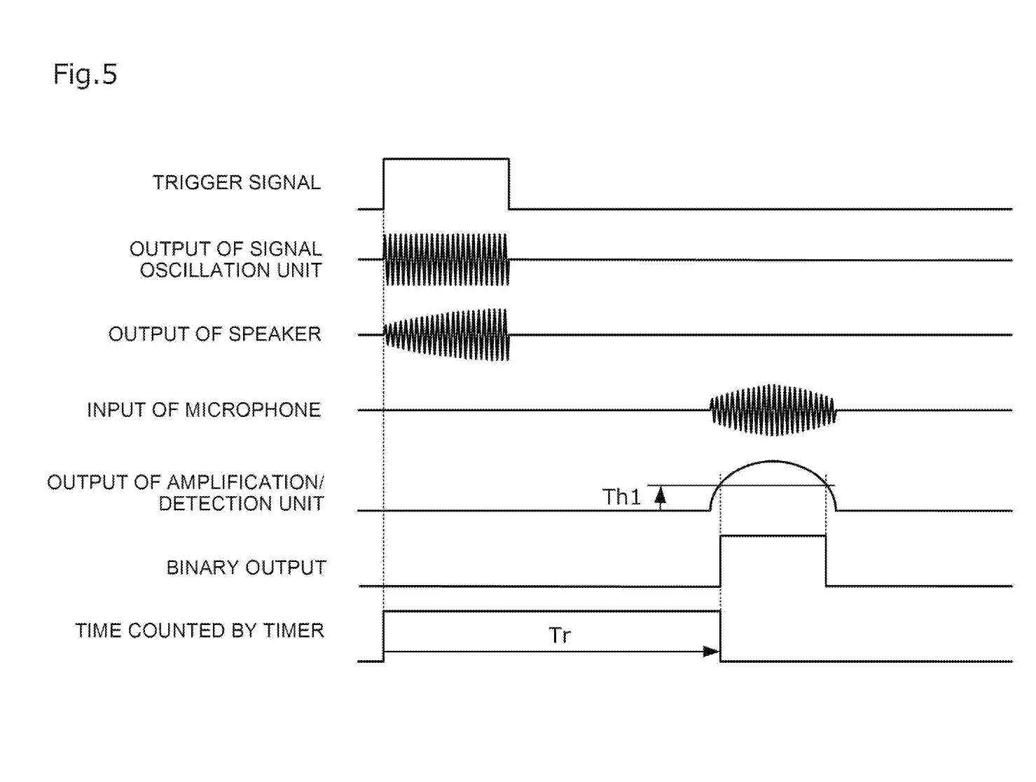

FIG. 5 is a waveform chart illustrating one example of a signal waveform of the front ultrasonic sensor 14F in FIG. 4. As illustrated in FIG. 5, the front ultrasonic sensor 14F sequentially receives a trigger signal, which is an instruction from the control unit 11, during traveling. An interval of the trigger signal is 500 milliseconds, for example. The signal oscillation unit 125 generates a pulse signal during a predetermined period (see “output of signal oscillation unit” in FIG. 5) in response to the trigger signal. The period in which the pulse signal is generated is 200 milliseconds, for example. The interval of the trigger signal and the period in which the pulse signal is generated as described above are merely one example. They may be determined by a designer according to a traveling speed of the self-propelled vacuum cleaner 1 and a detected distance to an obstacle, as needed. An ultrasonic signal corresponding to the pulse signal is emitted to the front side from the ultrasonic speaker 127 (see “output of speaker” in FIG. 5). When the obstacle 135 is present ahead, the ultrasonic wave is reflected (see “input of microphone” in FIG. 5). The ultrasonic microphone 129 converts the reflected ultrasonic wave into an electric signal. The amplification/detection unit 131 amplifies and rectifies the signal from the ultrasonic microphone 129 inside (see “output of amplification/detection unit” in FIG. 5). The amplification/detection unit 131 compares the rectified signal with a predetermined threshold value (first threshold value Th1), and outputs a binary signal (see “binary output” in FIG. 5).

The time difference measurement unit 133 measures a time (response time) Tr from when the pulse signal is generated from the signal oscillation unit till the rising of the binary output. When there is no obstacle 135 ahead, the emitted ultrasonic wave is not reflected. Therefore, the rising of the binary output is not generated, so that Tr becomes infinite theoretically. The maximum measurement time of a trigger signal is preferably limited to be not more than the intervals between trigger signals in order to enable distinction between the reflection with an obstacle and a reflection signal of a next emission pulse. The response time Tr varies according to a distance to the obstacle 135. The maximum detectable distance is determined by the intervals between trigger signals and the speed of the ultrasonic wave propagating through air. An output level of the amplification/detection unit differs depending on the shape of an obstacle and the distance to an obstacle. However, if an obstacle is present within the detectable range, the rising of the binary output is obtained by appropriately setting the first threshold value Th1. Further, the response time Tr according to the distance to an obstacle can be acquired without greatly depending on the shape of the obstacle.

As a modification, a part of the amplification/detection unit 131 and the time difference measurement unit 133 may be processed with software. For example, the output of the amplification/detection unit 131 may undergo A/D conversion to obtain digital data, and the comparison between the digital data and the first threshold value (Th1) may be performed with a software process. The binary output obtained as a result of the comparison becomes data, not a signal. The time difference may be measured with a software process.

### <<Flowchart>>

The flow of the process for stuck detection by the control unit 11 during traveling will be described.

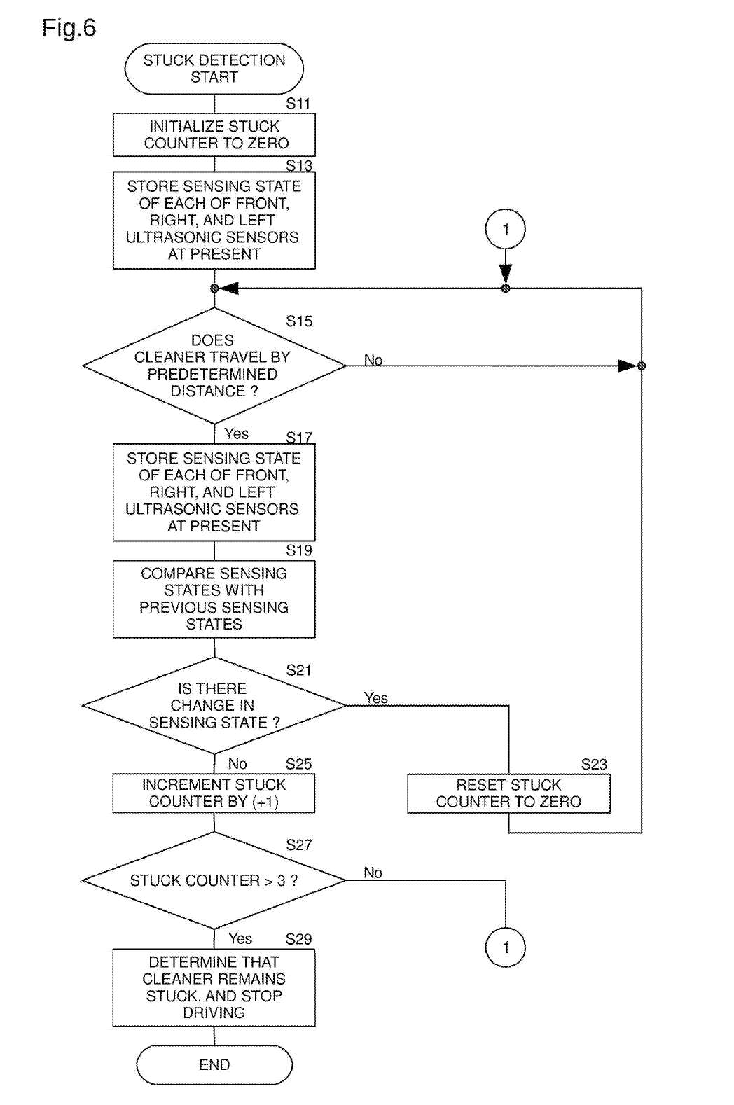

FIG. 6 is a flowchart illustrating a procedure of the process executed by the control unit 11 according to the present embodiment. The control unit 11 executes a task for stuck detection while the self-propelled vacuum cleaner 1 travels. The task is executed in parallel with other tasks under multitask environment. However, only the process for stuck detection will be illustrated in the form of the flowchart for easy understanding.

As illustrated in FIG. 6, the control unit 11 initializes a stuck detection counter to zero at the point at which the self-propelled vacuum cleaner 1 starts to travel (step S11), and stores the sensing state of each of the front ultrasonic sensor 14F, the left ultrasonic sensor 14L, and the right ultrasonic sensor 14R at this point, that is, the presence of an obstacle and the distance to an obstacle at this point, into the RAM (step S13).

Then, after waiting till the self-propelled vacuum cleaner 1 travels by a predetermined distance (step S15), the control unit 11 stores the sensing state of each of the front ultrasonic sensor 14F, the left ultrasonic sensor 14L, and the right ultrasonic sensor 14R at this point into a region of the RAM different from the region for the previous sensing state (step S17). The sensing state means the presence of an obstacle and the distance to the obstacle here. The control unit 11 checks whether there is a change in the sensing state of each sensor from the previous sensing state (steps S19 and S21).

When there is a change in the sensing state of any one of the sensors (Yes in step S21), the control unit 11 resets the stuck detection counter to zero (step S23). Then, the routine returns to the above step S15 where the control unit 11 waits till the self-propelled vacuum cleaner 1 further travels by a predetermined distance.

On the other hand, when there is no change in the sensing state of any one of the sensors from the previous sensing state (No in step S21), the control unit 11 increments the value of the stuck detection counter by one (step S25). Then, the control unit 11 checks whether the value of the stuck detection counter exceeds three or not (step S27).

When the value of the stuck detection counter is equal to or lower than three (No in step S27), the routine returns to the above step S15 where the control unit 11 waits till the self-propelled vacuum cleaner 1 further travels by a predetermined distance. Note that the threshold value “three” compared to the value of the stuck detection counter in the above step S27 is merely one example.

On the other hand, when the value of the stuck detection counter exceeds three (Yes in step S27), the control unit 11 determines that the self-propelled vacuum cleaner 1 remains stuck, and stops driving operation of the drive unit 21 (step S29). At this time, the control unit 11 may execute a traveling pattern for allowing the self-propelled vacuum cleaner 1 to be free from the stuck state. For example, the control unit 11 may allow the self-propelled vacuum cleaner 1 to move backward by a predetermined distance and check whether the sensing state of the ultrasonic sensor is changed or not.

The control unit 11 may also issue an alarm sound from a speaker not illustrated in FIG. 1 or display a warning on a display unit mounted on the operation panel of the input unit 51, in order to inform the user of the condition in which the self-propelled vacuum cleaner 1 is in the stuck state. Alternatively, the power source may be turned off to prevent unnecessary battery drain of the rechargeable battery 12.

Thereafter, the control unit 11 ends the process for stuck detection.

### Second Embodiment

The first embodiment uses an ultrasonic sensor for stuck detection. However, the present embodiment uses a camera for stuck detection. The self-propelled vacuum cleaner 1 includes the camera 113C in FIG. 1. The camera 113C sequentially transmits an image to a remote user in real time so as to allow the user to confirm the condition in the room where the self-propelled vacuum cleaner 1 is placed. Alternatively, the image analyzing unit 113A sequentially analyzes an image of the camera to recognize the direction and distance to an obstacle during traveling, and the control unit 11 controls the drive unit 21 to avoid collision against the obstacle.

The control unit 11 determines whether or not a frame image sequentially output from the camera 113C is changed with time during traveling. The image analyzing unit 113A may analyze whether there is a change or not in order to assist the process of the control unit 11. When there is no change in each frame image even during traveling, or when there is a change but this change is very small, the control unit 11 determines that the self-propelled vacuum cleaner 1 is in the stuck state. The case where there is a change but this change is very small is set in consideration of the case where an image blur occurs due to the vibration caused by the activation of the drive unit 21 in the self-propelled vacuum cleaner 1. When there is no change even beyond a distance and a time by which the vacuum cleaner 1 travels in a sufficiently wide region, the control unit 11 determines that the self-propelled vacuum cleaner 1 is in the stuck state, as in the first embodiment.

### <<Flowchart>>

The flow of the process for stuck detection by the control unit 11 during traveling will be described.

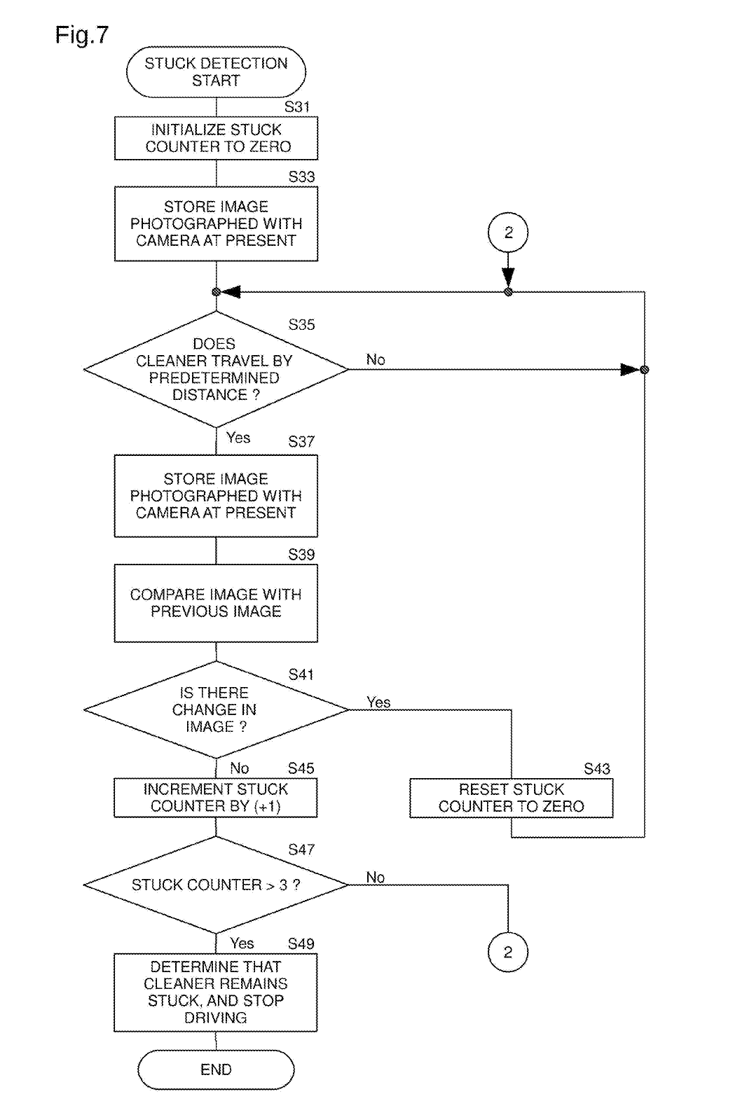

FIG. 7 is a flowchart illustrating a procedure of the process executed by the control unit 11 according to the present embodiment. The control unit 11 executes a task for stuck detection while the self-propelled vacuum cleaner 1 travels. The task is executed in parallel with other tasks under multitask environment. However, only the process for stuck detection will be illustrated in the form of the flowchart for easy understanding.

As illustrated in FIG. 7, the control unit 11 initializes the stuck detection counter to zero at the point at which the self-propelled vacuum cleaner 1 starts to travel (step S31), and stores a frame image photographed by the camera 113C at this point into the RAM (step S33).

Then, after waiting till the self-propelled vacuum cleaner 1 travels by a predetermined distance (step S35), the control unit 11 stores the frame image photographed by the camera 113C at this point into a region of the RAM different from the region for the previous frame image (step S37). The control unit 11 then checks whether or not there is a change in the frame image from the previous frame image (steps S39 and S41).

When there is a change in the frame image from the previous frame image (Yes in step S41), the control unit 11 resets the stuck detection counter to zero (step S43). Then, the routine returns to the above step S35 where the control unit 11 waits till the self-propelled vacuum cleaner 1 further travels by a predetermined distance.

On the other hand, when there is no change from the previous frame image in step S41 (No in step S41), the control unit 11 increments the value of the stuck detection counter by one (step S45). Then, the control unit 11 checks whether the value of the stuck detection counter exceeds three or not (step S47).

When the value of the stuck detection counter is equal to or lower than three (No in step S47), the routine returns to the above step S35 where the control unit 11 waits till the self-propelled vacuum cleaner 1 further travels by a predetermined distance. Note that the threshold value “three” compared to the value of the stuck detection counter in the above step S47 is merely one example.

On the other hand, when the value of the stuck detection counter exceeds three (Yes in step S47), the control unit 11 determines that the self-propelled vacuum cleaner 1 remains stuck, and stops driving operation of the drive unit 21 (step S49). At this time, the control unit 11 may execute a traveling pattern for allowing the self-propelled vacuum cleaner 1 to be free from the stuck state. For example, the control unit 11 may allow the self-propelled vacuum cleaner 1 to move backward by a predetermined distance and check whether the image photographed by the camera is changed or not. Besides, the control unit 11 may also issue an alarm sound, display a warning on a display unit, or turn off the power source. Thereafter, the control unit 11 ends the process for stuck detection.

### Third Embodiment

In the first and second embodiments, the control unit 11 determines that the self-propelled vacuum cleaner 1 remains stuck, and stops driving operation, when the value of the stuck detection counter exceeds a predetermined threshold value during traveling. In the present embodiment, the control unit 11 changes the traveling direction before stopping the driving operation, and checks whether the states of the sensors are changed or not. Preferably, whether the states of the sensors are changed or not is confirmed after the traveling direction is changed 360 degrees. With this, erroneous detection in which the self-propelled vacuum cleaner 1 is determined to be in a stuck state when traveling in a wide region having no obstacles can more reliably be prevented.

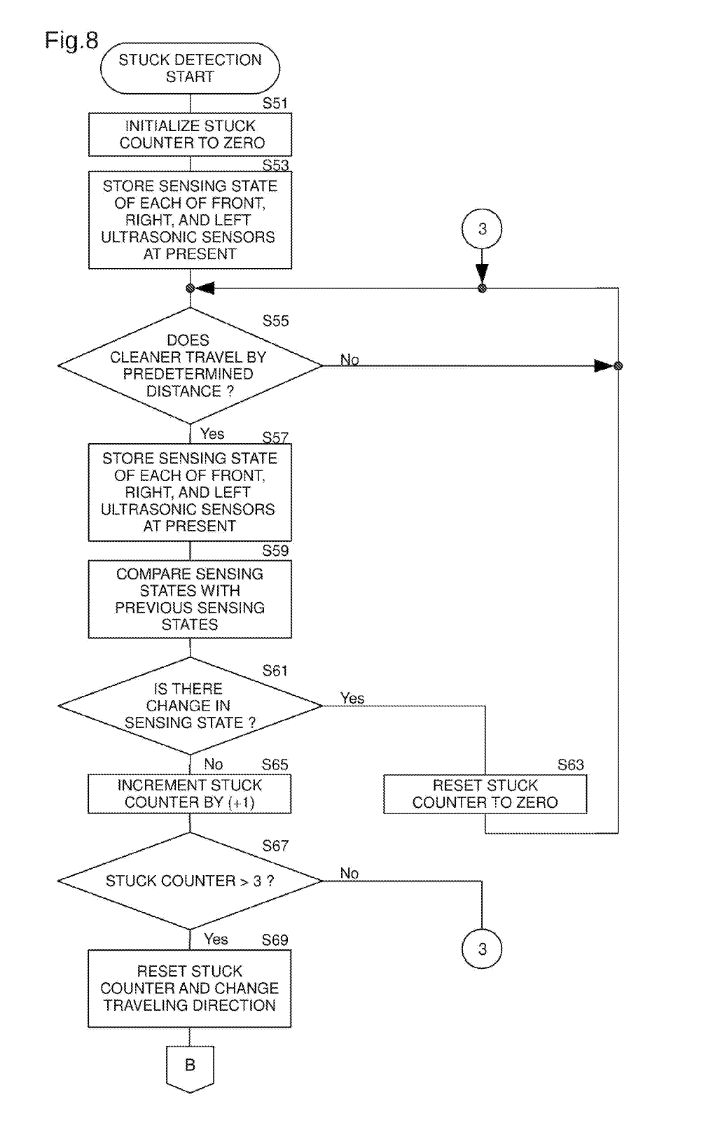

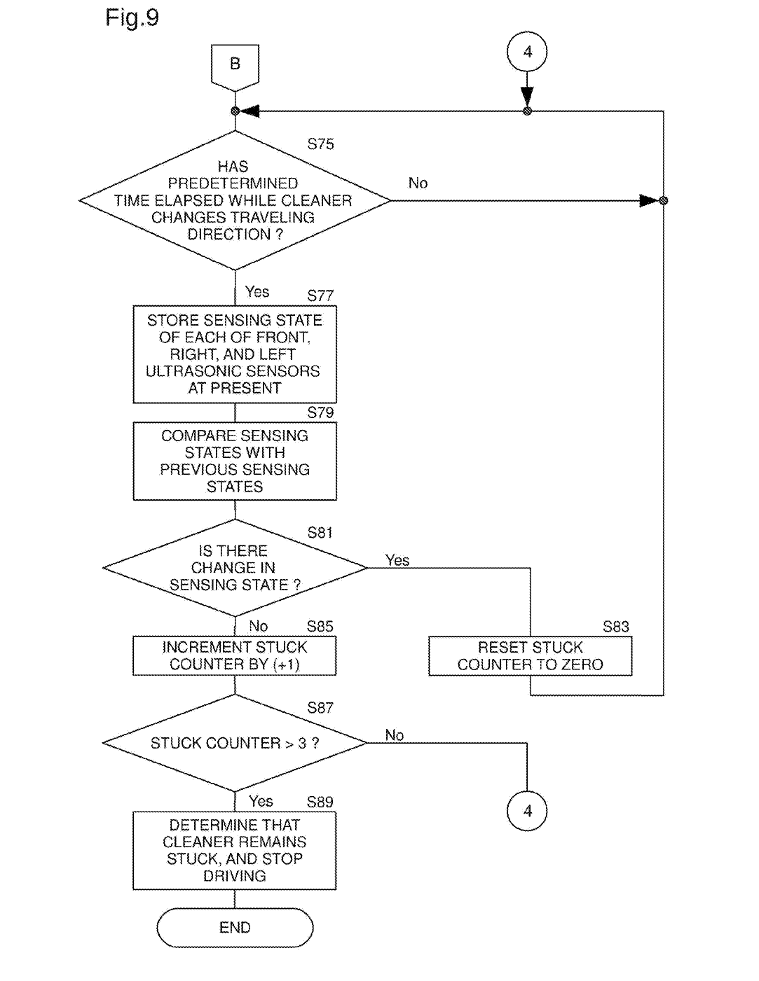

FIGS. 8 and 9 are flowcharts illustrating the procedure of a process executed by the control unit 11 in the present embodiment. Steps S51 to S67 in FIG. 8 respectively correspond to steps S11 to S27 in FIG. 6. Therefore, their description will be omitted.

When the value of the stuck detection counter exceeds three in step S67, the control unit 11 temporarily resets the stuck detection counter, and controls the drive unit 21 to change the traveling direction (step S69). After waiting till a predetermined time has elapsed or the self-propelled vacuum cleaner 1 travels by a predetermined distance, while changing the direction (step S75 in FIG. 9), the control unit 11 stores the sensing state of each of the front ultrasonic sensor 14F, the left ultrasonic sensor 14L, and the right ultrasonic sensor 14R at this point into a region of the RAM different from the region for the previous sensing state (step S77). The control unit 11 checks whether there is a change in the sensing state of each sensor from the previous sensing state (steps S79 and S81).

When there is a change in the sensing state of any one of the sensors (Yes in step S81), the control unit 11 resets the stuck detection counter to zero (step S83). Then, the routine returns to the above step S75 where the control unit 11 waits till a predetermined time has further elapsed or the self-propelled vacuum cleaner 1 further travels by a predetermined distance, while changing the direction.

On the other hand, when there is no change in the sensing state of any one of the sensors (No in step S81), the control unit 11 increments the value of the stuck detection counter by one (step S85). Then, the control unit 11 checks whether the value of the stuck detection counter exceeds three or not (step S87).

When the value of the stuck detection counter is equal to or lower than three (No in step S87), the routine returns to the above step S75 where the control unit 11 waits till a predetermined time has further elapsed or the self-propelled vacuum cleaner 1 further travels by a predetermined distance.

On the other hand, when the value of the stuck detection counter exceeds three (Yes in step S87), the control unit 11 determines that the self-propelled vacuum cleaner 1 remains stuck, and stops driving operation of the drive unit 21 (step S89).

Notably, the control unit 11 may execute a traveling pattern for allowing the self-propelled vacuum cleaner 1 to be free from the stuck state, for example, may allow the self-propelled vacuum cleaner 1 to move backward by a predetermined distance, and check whether the sensing state of the ultrasonic sensor is changed or not. Besides, the control unit 11 may also issue an alarm sound, display a warning on a display unit, or turn off the power source, as in the first embodiment.

### Fourth Embodiment

In FIG. 5 described above, the amplification/detection unit 131 amplifies and rectifies a signal from the ultrasonic microphone 129 inside, compares the resultant with the first threshold value Th1, and outputs a binary signal; and the time difference measurement unit 133 measures the time Tr from when a pulse signal is generated from the signal oscillation unit till the rising of the binary output to detect the presence of an obstacle and measure the distance to the obstacle. In addition, the control unit 11 determines that the self-propelled vacuum cleaner 1 is brought into a stuck state, if there is no change in the presence of an obstacle and the distance to the obstacle during the stuck detection.

According to the present embodiment, the amplification/detection unit 131 applies a threshold value (second threshold value Th2) different from the first threshold value (Th1) for the stuck detection. Specifically, different two binary outputs may be generated for the stuck detection. The second threshold value (Th2) is set lower than the first threshold value (Th1). This is equivalent to the setting in which the sensitivity of the ultrasonic sensor is increased more than that for the detection of an obstacle. Specifically, a rising of a binary output appears even with a small change. Accordingly, a situation in which the self-propelled vacuum cleaner 1 is erroneously determined to be in a stuck state can more reliably be prevented.

As described above,

(i) A self-propelled electronic device according to the present invention is characterized by including: a housing capable of traveling on a travel surface; a drive unit for driving the housing to travel; a traveling sensor for sensing a condition on the travel surface and for outputting a signal; and a control unit for controlling the drive unit based on the signal output from the traveling sensor, wherein the control unit controls to stop driving operation of the drive unit to stop in a case of determining that there is no change in the signal output from the traveling sensor while the housing travels for a predetermined travel distance or for a predetermined period.

In the present invention, a self-propelled electronic device autonomously travels on a travel surface to perform a job or the like. The specific embodiment of the self-propelled electronic device is, for example, a robotic vacuum cleaner or a self-propelled air cleaner. In the above embodiments, the self-propelled electronic device has an embodiment of a robotic cleaner.

The travel surface is a place on which the self-propelled electronic device travels. It is not always necessarily flat, and may have some height difference or slope. The specific embodiment of the travel surface is a floor surface in a room where the robotic vacuum cleaner is placed, for example.

The traveling sensor senses a condition on a travel surface. The specific embodiment thereof is an obstacle sensor sensing an obstacle on a travel surface, for example. Alternatively, it is a camera that sequentially photographs a condition on a travel surface or a condition around the device.

The drive unit drives to make the housing travel, and it is a drive motor for driving a drive wheel mounted to the housing and a drive circuit for activating the drive motor, for example.

The control unit controls the drive unit based on a signal from the traveling sensor. Specifically, the function as the control unit is implemented by the execution of a control program, which is stored beforehand in a ROM, by a microcomputer, for example.

Preferable embodiments of the present invention will further be described.

(ii) The traveling sensor may be an obstacle sensor that for sensing an obstacle on the travel surface in a non-contact manner and for outputting a sensing signal according to a distance to the obstacle on the travel surface, and the control unit may control the drive unit to travel by avoiding the obstacle based on a signal obtained by comparing the sensing signal with a predetermined first threshold value, and determine whether or not there is a change in the sensing signal based on a signal obtained by comparing the sensing signal with a second threshold value different from the first threshold value.

With this, the control unit determines whether the device remains stuck or not based on the second threshold value lower than the first threshold value that is used to determine the presence of an obstacle. Therefore, this configuration can prevent the control unit from erroneously determining that the device remains stuck when an obstacle is present far away, for example.

Note that signals obtained by comparing the sensing signal with the predetermined first threshold value and second threshold value are not limited to a mere electric signal, and they may be data in which the comparison with the first and second threshold values is processed with software. Specifically, they mean signals including data or information in a broad sense.

(iii) The obstacle sensor may include a plurality of sensors having different sensing regions, respectively, and the control unit may stop driving operation of the drive unit when determining that there is no change in sensing signal from every one of the sensors.

This configuration can prevent the control unit from erroneously determining that the device remains stuck, when an obstacle is present in only one of the different sensing regions, and other regions have no obstacle.

(iv) The traveling sensor may include a camera for sequentially photographing the travel surface and outputs signals, each of which corresponds to an image of each time frame, and the control unit may determine that there is no change in the signal in a case where there is no difference between images sequentially output from the camera.

With this configuration, the self-propelled electronic device includes a camera that informs a remote user of a condition of a location where the device is placed, and the control unit can determine whether the device is stuck or not using the camera. Accordingly, whether the device is stuck or not can be determined without providing a dedicated sensor or circuit.

(v) The control unit may control the drive unit to change a traveling direction of the housing when determining that there is no change in a signal output from the traveling sensor while the housing travels for a predetermined travel distance or for a predetermined period, and the control unit may also control driving operation of the drive unit to stop when determining that there is no change in a signal output from the traveling sensor while a traveling direction is controlled to be changed.

According to this configuration, when the device might be stuck without any change in a signal output from the traveling sensor, the control unit confirms whether the signal output from the traveling sensor is changed or not while changing the traveling direction. With this, erroneous determination in which the device is stuck can be prevented.

Preferable embodiments of the present invention include a combination of any of the above two or more embodiments.

In addition to the above-described embodiments, there can be various modified examples of the invention. Such modified examples should not be deemed to be out of the scope of the invention. The invention should include all the modified examples within the meaning and range of equivalency of scope of the claims.

### EXPLANATION OF NUMERALS

10 Self-propelled vacuum cleaner
2 Housing
2a Bottom plate
2b Top plate
2c Side plate
3 Lid unit
9 Rotary brush
10 Side brush
11 Control unit
12 Rechargeable battery
14 Traveling sensor
14C Collision sensor
14F Front ultrasonic sensor
14L Left ultrasonic sensor
14R Right ultrasonic sensor
15 Dust collection unit
18 Front-wheel floor surface detection sensor
19L Left-wheel floor surface detection sensor
19R Right-wheel floor surface detection sensor
21 Drive unit
22L Left drive wheel
22R Right drive wheel
26 Rear wheel
27 Front wheel
31 Intake port
32 Exhaust port
51 Input unit
52M Main power switch
52S Power switch
53 Start switch
61 Storage unit
62 Battery information
63 Position information
71 Operation mode information
72 Running mode
73 Stand-by mode
74 Sleep mode
113A Image analyzing unit
113C Camera
115 Electric air blower
117 Ion generation unit
119 Brush motor
121 Communication unit
125 Signal oscillation unit
127 Ultrasonic speaker
129 Ultrasonic microphone
131 Amplification/detection unit
132 Time difference measurement unit
135 Obstacle

1: A self-propelled electronic device comprising:
a housing capable of traveling on a travel surface;
a drive unit for driving the housing to travel;
a traveling sensor for sensing a condition on the travel surface and for outputting a signal; and
a control unit for controlling the drive unit based on the signal output from the traveling sensor, wherein
the control unit controls driving operation of the drive unit to stop when determining that there is no change in the signal output from the traveling sensor while the housing travels for a predetermined travel distance or for a predetermined period.

2: The self-propelled electronic device according to claim 1, wherein
the traveling sensor is an obstacle sensor for sensing an obstacle on the travel surface in a non-contact manner and for outputting a sensing signal according to a distance to the obstacle on the travel surface, and
the control unit controls the drive unit to travel by avoiding the obstacle based on a signal obtained by comparing the sensing signal with a predetermined first threshold value, and determines whether or not there is a change in the sensing signal based on a signal obtained by comparing the sensing signal with a second threshold value different from the first threshold value.

3: The self-propelled electronic device according to claim 2, wherein
the obstacle sensor includes a plurality of sensors having different sensing regions, respectively, and
the control unit stops driving operation of the drive unit when determining that there is no change in sensing signal from every one of the sensors.

4: The self-propelled electronic device according to claim 1, wherein
the traveling sensor includes a camera for sequentially photographing the travel surface and outputs signals, each of which corresponds to an image of each time frame, and
the control unit determines that there is no change in the signal in a case where there is no difference between images sequentially output from the camera.

5: The self-propelled electronic device according to claim 1, wherein
the control unit controls the drive unit to change a traveling direction of the housing when determining that there is no change in a signal output from the traveling sensor while the housing travels for a predetermined travel distance or for a predetermined period, and the control unit also controls driving operation of the drive unit to stop when determining that there is no change in a signal output from the traveling sensor while a traveling direction is controlled to be changed.
